(19) United States
(12) Patent Application Publication
(10) Pub. No.: US 2014/0266049 A1
(43) Pub. Date: Sep. 18, 2014

(54) DETECTION AND PREVENTION OF SHORT FORMATION IN BATTERY CELLS

(71) Applicant: Southwest Electronic Energy Group, Missouri City, TX (US)

(72) Inventors: Claude Leonard Benckenstein, JR., Stafford, TX (US); David Allen White, Houston, TX (US)

(21) Appl. No.: 13/844,350

(22) Filed: Mar. 15, 2013

(51) Int. Cl. H02J 7/00

(52) U.S. Cl. CPC H02J 7/0031
USPC 320/112; 320/162

(57) ABSTRACT

Failure mechanisms of a battery cell may be detected and prevented by monitoring a voltage of the battery cell, and detecting when the cell voltage falls below a voltage threshold. The length of time that the voltage remains below the voltage threshold may be monitored to detect when the length of time exceeds a time threshold. When the length of time has exceeded the time threshold, the battery pack may be disabled from further charging.

### TECHNICAL FIELD

The present disclosure generally relates to battery cells and, more particularly, a system for detecting and preventing failure mechanisms in battery packs.

### BACKGROUND

A device powered by rechargeable batteries may include several rechargeable battery cells to achieve the voltage and/or current levels used by the device. For example, if a rechargeable battery cell has a nominal output voltage of 1 Volt, then a device having a 2 Volt operational level may include two battery cells placed in series. In another example, if a rechargeable battery cell has a nominal output current of 100 milliamps, then a device having a 400 milliamp operational level may include four battery cells in parallel. Battery cells in parallel and series may be further combined to reach the operational levels of the device.

The battery cells may also be grouped to form a battery pack system module. Multiple battery pack system modules may be combined in series or parallel to further increase the output voltage and/or output current available to a device coupled to the battery pack system modules. The battery cells may be recharged individually or may be recharged in groups through charging of battery pack system modules. The voltage potential level to which a battery cell is discharged or charged is critical to the performance and lifetime of the battery cell. Many of the mechanisms that degrade the performance of a battery cell, and which may ultimately result in complete failure of the battery cell, result from the levels to which the battery cell is discharged.

Over-discharging a battery cell may cause a battery cell to fail. Over-discharge occurs when a battery cell is discharged to a level below a discharge voltage limit, where the discharge voltage limit is typically specific to the type of rechargeable battery cell in use. Over-discharge of a Lithium-ion battery cell may lead to thermal runaway through a process of: 1) the cell voltage dropping below a copper dissolution voltage; 2) copper dissolving into the electrolyte; and, 3) when the cell is recharged, Lithium dendrites being plated onto or within an anode of the battery cell, which may penetrate the cell separator and electrically short the anode with the cathode vigorously enough to result in a thermal run away event.

Conventional systems have attempted to prevent battery cells from over-discharging by preventing the cell from discharging when the cell voltage reaches a low voltage threshold value followed by preventing subsequent charging at high current. The intent of stopping discharge is to prevent cell damage associated with a discharge voltage so low that the cell cannot recover its original capacity. The intent of stopping subsequent charging at high current is to prevent damage to the cell associated with the cell's inability to accept high current charge when the cell voltage is below a high charge current threshold voltage. Following the prevention of the cells' discharging and the subsequent attachment of a charger, the conventional system then allows or makes the battery cell to recharge at a very low or intermittent rate until the cell exceeds the high charge current threshold voltage at which time high current charging can commence and normal cell capacity can be recovered.

This conventional approach at over-discharge protection does not take into consideration that a long time can transpire between stopping discharging and the subsequent attachment of a charger. After discharge is stopped the cell will continue to self-discharge internally and, given enough time, can self-discharge severely enough that its anode voltage is below the copper dissolution voltage which will result in the anode's copper current collector slowly dissolving in the cell's electrolyte. When this happens, subsequent attachment of a charger and slow or fast recharge of the cell will result in dissolved copper materializing from the solution and plating copper onto or into the anode carbon structure, which reduces or prevents acceptance of intercalated Lithium ions into the anode carbon structure. Continued charge current, even at a low current rate, can then forcibly plate lithium metal onto or into the anode in the form of Lithium dendrites, which may then short the anode to the cathode during charging or at a later time due to external physical changes, such as temperature and pressure. This short may result in internal cell heating which, if severe enough, can then result in an unstable and dangerous situation called thermal run away.

### BRIEF SUMMARY

According to one embodiment, a method includes monitoring a voltage of at least a battery cell, recording a length of time the cell voltage is below a voltage threshold, detecting when the length of time exceeds a time threshold, and disabling charging of the battery cell when the length of time has exceeded the time threshold.

According to another embodiment, a computer program product includes a non-transitory computer readable medium comprising code to perform the steps of monitoring a voltage of at least a battery cell, recording a length of time the cell voltage is below a voltage threshold, detecting when the length of time exceeds a time threshold, and disabling charging of the battery cell when the length of time has exceeded the time threshold.

According to yet another embodiment, an apparatus includes a battery pack coupled to a first terminal, wherein the battery pack comprises at least one battery cell and at least one charge switch coupled to the at least one battery cell; and a control module coupled to each of the at least one battery cells and each of the at least one charge switches. The control module may be configured to perform the steps of monitoring a voltage of the at least one battery cell, recording a length of time the cell voltage is below a voltage threshold, detecting when the length of time exceeds a time threshold, and disabling charging of the at least one battery cell when the length of time has exceeded the time threshold.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiments disclosed may be readily used as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present disclosure, reference is now made to the following descriptions taken in conjunction with the accompanying drawings.

FIG. 1 is a schematic diagram illustrating a battery pack system module having battery packs, charge switches, bypass switches, and a control module according to one embodiment.

FIG. 2 is a flow chart illustrating a method of detecting and preventing failure mechanisms in battery packs according to one embodiment.

### DETAILED DESCRIPTION

A battery pack system having a plurality of battery pack system modules may detect and prevent failure in battery cells by including charge switches, bypass switches, and control modules. For example, copper dissolution may be reduced or prevented from causing failure in a battery cell by preventing the battery cell from charging when the voltage level of the battery cell was below a voltage threshold level long enough that copper dissolution may occur. A control module of a battery pack may determine when the voltage level of a battery cell is below a specified voltage threshold. The control module may then record how long the cell voltage is below the voltage threshold. If the voltage level remains below the voltage threshold longer than a time threshold, then the battery pack may disable the battery cell from receiving charging current. A charge switch may be coupled to each battery cell of the battery pack, which when activates and disables charging of the battery cell. Furthermore, a charge switch may be coupled to each battery pack to prevent charge current from passing through all battery cells of the battery pack, thereby disabling the battery pack from any subsequent charging.

FIG. 1 is a schematic diagram illustrating an exemplary battery pack system module having battery packs, charge switches, bypass switches, and a control module according to one embodiment. A first group of components may include a battery cell 112, a charge switch 116, and a bypass switch 120. The components may be coupled in series with a second group of components including a second battery cell 114, a second charge switch 118, and a second bypass switch 122. Although not shown, additional similar groups of components may be coupled in series or in parallel with the first and second groups of components. A battery pack charge switch 130 may be coupled in series with the first group of components and the second group of components. A positive battery terminal 102 and a negative battery terminal 104 may be coupled with the module charge switch 130, the first group of components, and the second group of components. A load (not shown) may be coupled between the terminals 102 and 104 to receive an output voltage and/or output current from the battery cells 112 and 114. The terminals 102 and 104 may also provide charge current for charging the cells 112 and 114.

The terminals 102 and 104 may be coupled to other battery pack system modules (not shown) in parallel or series. The battery cells 112 and 114 may be electrochemical cells such as lithium ion (Li-ion) battery cells, nickel-metal hydroxide (NiMH) battery cells, nickel cadmium (NiCd) battery cells, lead-acid battery cells, or a combination thereof.

A control module 106 may be coupled to each of the battery cells 112 and 114 within the battery pack, to each of the charge switches 116 and 118, to each of the bypass switches 120 and 122, and to the module charge switch 130. The control module 106 may include an analog controller 140, a microprocessor 142, and/or other discrete analog and/or digital components (not shown). The analog controller 140 may include circuitry to measure characteristics, current status, and voltages of each of the battery cells within the battery cells 112 and 114. The analog controller 140 may also monitor for short circuits within the battery cells. The microprocessor 142 may receive information about the battery cells 112 and 114 from the analog controller 140, and the microprocessor may issue commands to the analog controller 140. Further details of the analog controller 140 and the microprocessor 142 are described in U.S. patent application Ser. No. 13/494,502 (published as U.S. Patent Application Publication No. 2012/0319658) entitled “Module Bypass Switch with Bypass Current Monitoring” to White et al. filed on Jun. 12, 2012, which is hereby incorporated by reference in its entirety.

The control module 106 may be configured to detect and prevent failure mechanisms in battery cells. For example, the control module 106 may be configured to monitor a voltage of the battery cell 112 to detect when the voltage falls below a voltage threshold. In order to detect when the voltage falls below the voltage threshold, the control module 106 may be further configured to compare the cell voltage of the battery cell 112 to the voltage threshold, and determine if the cell voltage is below or above the voltage threshold.

The control module 106 may also be configured to monitor a length of time the cell voltage is below the voltage threshold and detect when the length of time exceeds a time threshold. The control module 106 may be further configured to compare the length of time to the time threshold, and determine if the length of time is below or above the time threshold. When the length of time that the voltage level of the battery cell within the battery pack 112 is below the voltage threshold exceeds the time threshold, the control module 106 may disable the battery pack 112 from receiving charge current. For example, the charge switch 116 coupled in series with the battery pack 112 may be opened to disable the battery cell 112 from being charged.

The voltage threshold and the time threshold may both be adjustable and may each be determined by a user input, a lookup table located within the control module, or a computer algorithm executed by the microprocessor 142. For example, the voltage threshold and/or the time threshold may be adjusted to account for the chemistry of the battery cell, the age of the battery cell, the temperature of the battery cell, or other measurable characteristics of the battery cell.

Other discrete analog and/or digital components (not shown) may be included within the control module 106. For example, a voltage regulator may be included to power components or controllers of the control module, such as the analog controller 140 and microprocessor 142, through an external charger (not shown) coupled to the voltage regulator. As another example, an analog/digital converter (not shown) may be coupled to the microprocessor and the analog controller.

Charge switches 116 and 118 may be coupled in series with the battery cells 112 and 114. According to one embodiment, the charge switches 116 and 118 may be field effect transistors (FETs). The charge switches 116 and 118 may be controlled by the analog controller 140. Opening (i.e., de-activating) the charge switch 116 coupled to the battery cell 112 may prevents charge current from passing through the battery cell 112. The bypass switch 120 may allow charge current to continue to the battery cell 114.

Bypass switch 120 may be coupled in parallel with the series combination of the battery cell 112 and the charge switch 116. Bypass switch 122 may be coupled in parallel with the series combination of the battery cell 114 and the charge switch 118. The bypass switch 120 may be closed to allow other battery cells, such as those that have not experienced over-discharging, to charge during a subsequent battery cell recharging phase while the battery cell 112 is prevented from being charged. Because the charge switches 116 and 118 physically disconnect the battery cells 112 and 114 from terminals of the battery pack, and because there is no resistor in series with the bypass switches 116 and 118 as in conventional systems, little to no power is dissipated when the bypass switches 116 and 118 are closed. The reduction in the dissipated power reduces heat generated in the battery pack system module, and reduces safety hazards experienced by the battery pack system and the operator of a device including the battery pack system.

Although not shown, a discharge switch may present in the battery pack system module of FIG. 1. A discharge switch provides a battery system with the ability to connect or disconnect the battery cells to a load independent of connecting or disconnecting the battery cells from the charger. Additional details of a battery pack system module with a discharge switch are described in U.S. patent application Ser. No. 13/494,502 filed Jun. 12, 2012 and entitled “Module Bypass Switch with Bypass Current Monitoring,” which is hereby incorporated by reference in its entirety. The discharge switch may controlled to disconnect battery cells from the load when the cells fall below a first low voltage threshold, such as the copper dissolution voltage threshold. Subsequent to this, the control module 106 may allow charging of the battery cells at a current below a fast charge rate or at a fast charge rate depending on whether the cell voltage is below or above a second threshold voltage. When the cell voltage is below a third threshold voltage for a specific adjustable period of time, further charging of the cell or module may be prevented.

A module charge switch 130 may be coupled in series with the first group of components, the second group of components, and the terminal 102. The module charge switch 130 may be controlled by the analog controller 140. When activated, the module charge switch 130 may deactivate charging of the battery cells 112 and 114, such as when the pack containing the cells 112 and 114 is being replaced or undergoing maintenance.

The switches disclosed herein may not be limited strictly to only a switch component or a plurality of switch components. That is, each switch disclosed herein may include a circuit composed of a plurality of devices that, when combined to create a circuit, may be referred to as a switch.

FIG. 2 is a flow chart illustrating an exemplary method of detecting and preventing failure mechanisms in battery packs according to one embodiment. A method 200 begins at block 202, where a voltage of at least one battery cell may be monitored. At block 204, the method 200 may detect when the cell voltage falls below a voltage threshold. In another embodiment the voltages of a plurality of battery cells may be monitored to detect when any of the voltages corresponding to any of the plurality of battery cells falls below the voltage threshold. Detecting when the voltage falls below a voltage threshold may include comparing the voltage to the voltage threshold, and determining if the voltage is below or above the voltage threshold. According to one embodiment, the voltage threshold for a Lithium-ion battery cell may be between approximately 1.0 Volt and 1.5 Volts.

At block 206, a length of time the voltage is below the voltage threshold may be recorded. At block 208, the method 200 detects when the recorded length of time exceeds a time threshold. In another embodiment, the time being monitored may be a plurality of times corresponding to a plurality of battery cells, and the detection may include detecting when any of the length of times exceed a time threshold. Detecting when the length of time exceeds a time threshold may include comparing the length of time to the time threshold, and determining if the length of time is below or above the time threshold. According to one embodiment, the time threshold for a Lithium-ion battery cell may be approximately thirty seconds.

When the length of time that a voltage level of a battery cell has been below the voltage threshold exceeds the time threshold, the battery cell may, at block 210, be disabled from receiving further charge current. For example, a charge switch coupled in series with the battery cell may be opened to disconnect the battery pack from charge current.

The voltage threshold and the time threshold may both be adjustable and may each be determined by a user input, a lookup table, or a computer algorithm. For example, the voltage threshold and/or the time threshold may be adjusted to account for the type of battery cell, the age of the battery cell, the temperature of the battery cell, or other measurable characteristics of the battery cell.

According to one embodiment, the method 200 may be executing within a microprocessor or control module in parallel with other processes. For example, other processes may monitor parameters such as temperature, state of charge, and charge or discharge current. The other processes may also issue commands to the switches.

The method of FIG. 2 provides for detecting and preventing failure in battery cells by allowing a battery pack system module to have autonomous control over discharging and charging of battery cells within each respective battery pack system module without communication to a central computer. According to another embodiment, the battery pack system module may be in communication with an initializer, such as a microcontroller, for detecting and preventing failure in battery cells of battery pack system modules within a battery pack system. The method of FIG. 2 may be used in combination with a separate method for activating a module bypass switch executed by a bypass detection circuit, such as a bypass detection circuit 272. When used in combination with a bypass detection circuit, a microprocessor programmed to perform the steps of FIG. 2 may allow a configurable voltage for activating a module bypass switch in addition to a voltage that activates the bypass detection circuit.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
monitoring a voltage of at least a battery cell;
recording a length of time the cell voltage is below a voltage threshold;
detecting when the length of time exceeds a time threshold; and
disabling charging of the battery cell when the length of time has exceeded the time threshold.

2. The method of claim 1, wherein the voltage threshold is determined by at least one of a user input, a lookup table, and an algorithm.

3. The method of claim 2, wherein the voltage threshold is determined based, at least in part, on a chemistry of the battery cell.

4. The method of claim 1, wherein the voltage threshold is between approximately 1.0 Volt and 1.5 Volts.

5. The method of claim 1, wherein the time threshold is approximately 30 seconds.

6. The method of claim 1, wherein disabling the battery pack comprises opening a charge switch coupled to the battery cell.

7. A computer program product, comprising:
a non-transitory computer readable medium comprising code to perform the steps comprising:
monitoring a voltage of at least a battery cell;
recording a length of time the cell voltage is below a voltage threshold;
detecting when the length of time exceeds a time threshold; and
disabling charging of the battery cell when the length of time has exceeded the time threshold.

8. The computer program product of claim 7, wherein the voltage threshold is determined by at least one of a user input, a lookup table, and an algorithm.

9. The computer program product of claim 8, wherein the voltage threshold is determined based, at least in part, on a chemistry of the battery cell.

10. The computer program product of claim 7, wherein the voltage threshold is between approximately 1.0 Volt and 1.5 Volts.

11. The computer program product of claim 7, wherein the time threshold is approximately 30 seconds.

12. The computer program product of claim 7, wherein disabling the battery pack comprises opening a charge switch coupled to the battery cell.

13. An apparatus, comprising:
a battery pack coupled to a first terminal, wherein the battery pack comprises at least one battery cell and at least one charge switch coupled to the at least one battery cell; and
a control module coupled to each of the at least one battery cells and each of the at least one charge switches, wherein the control module is configured to perform the steps comprising:
monitoring a voltage of the at least a battery cell;
recording a length of time the cell voltage is below a voltage threshold;
detecting when the length of time exceeds a time threshold; and
disabling charging of the at least battery cell when the length of time has exceeded the time threshold.

14. The apparatus of claim 13, wherein the adjustable voltage threshold is determined by at least one of a user input, a lookup table, and an algorithm.

15. The apparatus of claim 14, wherein the voltage threshold is determined based, at least in part, on a chemistry of the at least one battery cell.

16. The apparatus of claim 13, wherein the voltage threshold is between approximately 1.0 Volt and 1.5 Volts.

17. The apparatus of claim 13, wherein the time threshold is approximately 30 seconds.

18. The apparatus of claim 11, wherein disabling the battery pack comprises opening the at least one charge switch coupled to the at least one battery cell.
